(19) United States
(12) Patent Application Publication
(10) Pub. No.: US 2009/0065623 A1
(43) Pub. Date: Mar. 12, 2009

(54) DEVICE AND METHOD FOR WINDING A COIL OF RIGID WIRE AROUND A RING CORE

(75) Inventor: Eric Touzet, Montlignon (FR)

Correspondence Address: LOWE HAUPTMAN & BERNER, LLP, 1700 DIAGONAL ROAD, SUITE 300, ALEXANDRIA, VA, 22314, US

(73) Assignee: THALES, NEUILLY SUR SEINE CEDEX (FR)

(21) Appl. No.: 11/577,719

(22) PCT Filed: Oct. 19, 2005
(86) PCT No.: PCT/EP05/55356

§ 371 Date: Apr. 22, 2007

(30) Foreign Application Priority Data
Oct. 22, 2004 (FR) 0411295

(51) Int. Cl. H01F 41/08

(52) U.S. Cl. 242/434.7

(57) ABSTRACT

The invention relates to a device for winding a coil and to a method of using the device. The invention is particularly beneficial for winding electromagnetic coils around a closed magnetic circuit having no opening, for example in the form of a ring core. The device comprises a helicoidal channel, means for holding the ring core in a defined position within the helicoidal channel, and thrust means for thrusting the wire (10) toward the helicoidal channel. The method employing the device consists in: engaging a first end of the wire in the thrust means for thrusting the wire (10) toward the helicoidal channel; placing the ring core in its defined position; thrusting the wire into the helicoidal channel until the desired number of turns have been formed; releasing the ring core and disengaging the wire from the thrust means; and cutting a second end of the wire.

### CROSS-REFERENCE TO RELATED APPLICATIONS

The present Application is based on International Application No. PCT/EP2005/055356, filed on Oct. 10, 2005, which in turn corresponds to France Application No. 0411295 filed on _Oct. 22, 2004, and priority is hereby claimed under 35 USC §119 based on these applications. Each of these applications are hereby incorporated by reference in their entirety into the present application.

### BACKGROUND OF THE INVENTION

The invention relates to a device for winding a coil and to a method of employing the device. The invention is particularly beneficial for winding electromagnetic coils around a closed magnetic circuit having no opening, for example in the form of a ring core. This type of magnetic circuit has the advantage of having no gap. The magnetic flux losses are consequently very small. However, winding coils around this type of circuit is problematic. This is because the fact that the circuit has no opening prevents the coil from being completely formed outside the magnetic circuit. This is all the more tricky when the wire used to form the coil is rigid.

To produce such coils, a parallel lathe has been used for preforming the coil around a spindle held in the chuck of the lathe. This spindle has substantially the inside diameter of the coil. The wire is guided in the wire guide fastened to the revolving turret of the lathe. Rotation of the spindle allows the wire to be wound around the spindle. Once the coil has been preformed, it is removed from the spindle. So as to place the coil in its definitive position around the magnetic circuit, the turns of the preformed coil are separated and an operation similar to screwing the coil onto the magnetic circuit is performed. Progressively as the turns of the coil take their place around the magnetic circuit, it is necessary for the turns to be closed up. During the operation of preforming the coil, the wire may undergo work hardening, and it is often necessary to perform an annealing operation on the preformed coil before the turns are separated from one another. This operating procedure is complex and comprises many manual operations, such as that of moving the turns apart and bringing them back together, and also the screwing of the coil around the magnetic circuit, that are difficult to implement on an industrial scale. In addition, the wire is generally covered by an electrical insulator, usually an enamel, which runs the risk of being damaged during these manual operations.

### SUMMARY OF THE INVENTION

The object of the invention is to mitigate the drawbacks of the coil production method proposed above, by providing a device and a method allowing a coil to be produced directly around a ring core, such as for example a closed magnetic circuit, without a preforming operation.

For this purpose, one subject of the invention is a device for winding a coil of rigid wire around a ring core, characterized in that it comprises a helicoidal channel, means for holding the ring core in a defined space within the helicoidal channel, and thrust means for thrusting the wire toward the helicoidal channel.

Advantageously, the helicoidal channel winds around a helix axis, the cross section of the helicoidal channel includes an end wall substantially facing the helix axis, the end wall is inclined to the helix axis and the inclination is that which the wire forms after winding along the helicoidal channel. This allows the winding of a wire with a non-circular, for example rectangular, cross section to be improved.

Although the invention is of particular benefit in the production of a coil around a closed-ring core, it is of course possible to use the device to produce a coil around an open-ring core.

Another subject of the invention is a method of winding a coil of rigid wire around a ring core, the method employing the device according to the invention, characterized in that it consists in:
engaging a first end of the wire in the thrust means for thrusting the wire toward the helicoidal channel;
forming a first half-turn with the end of the wire;
placing the half-turn in the helicoidal channel;
placing the ring core in its defined position;
thrusting the wire into the helicoidal channel until the desired number of turns have been formed;
releasing the ring core and disengaging the wire from the thrust means; and
cutting a second end of the wire.

By implementing the invention, the wire turns are wound directly around the ring core. This avoids intermediate deformation operations of separating the turns and bringing them back together. The annealing operation is therefore no longer necessary.

Furthermore, the intermediate deformation operations are manual operations. Thus, the winding carried out is in general not very regular. In contrast, by implementing the invention, the winding pitch of the turns is given by the pitch of the helix of the channel. A very regular pitch for all the turns of the coil is obtained.

### BRIEF DESCRIPTION OF THE DRAWINGS

The invention will be better understood and other advantages will appear on reading the detailed description of one embodiment given by way of example, the description being illustrated by the appended drawing in which:

FIG. 1 show two coils of rigid wire that are wound around a closed magnetic circuit;

FIG. 2 shows schematically an exemplary embodiment of the invention;

FIG. 3 shows in greater detail an exemplary embodiment of the thrust means for thrusting the wire;

FIGS. 4a and 4b show an exemplary embodiment of a helicoidal channel;

FIGS. 5a and 5b show an alternative embodiment of a helicoidal channel suitable for simultaneously winding two wires; and

FIGS. 6a and 6b show an example of means for preforming a first half-turn of the coil.

For the purposes of simplification, the same elements in the various figures will have the same reference numbers.

### DETAILED DESCRIPTION OF THE PREFERRED EMBODIMENTS

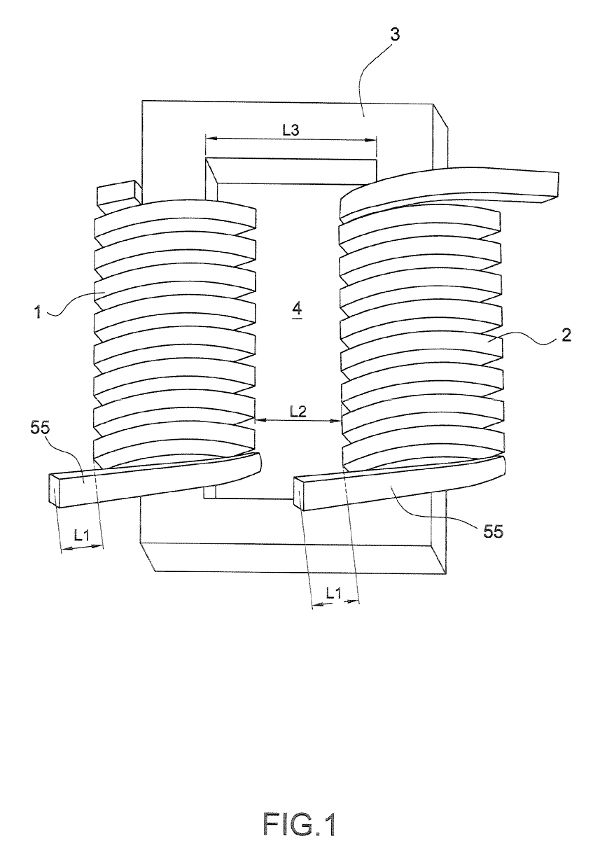

FIG. 1 shows two coils 1 and 2 of rigid wire that are wound around a closed magnetic circuit 3. The two coils 1 and 2 and the magnetic circuit 3 form a transformer. The magnetic circuit 3 has the shape of a rectangular disk pierced by a rectangular hole 4. The cross section of the magnetic circuit 3 is substantially constant, for example a square cross section. The magnetic circuit 3 is produced as one piece, with no gap. Consequently, the winding of each coil 1 or 2 can be performed only by passing the wire inside the hole 4 as many times as there are turns to be produced. The cross section of the wire used to produce the coils 1 and 2 is determined by the intensity of the current that will flow therethrough. In a given volume of the transformer, the largest wire cross section is obtained with a square or rectangular shape. Using a rectangular cross section, the number of turns possible is increased by winding the wire along its edge. The latter type of winding is particularly tricky to implement as a wire of rectangular cross section is wound more easily along its larger face than along its edge. The device of the invention allows such winding to be carried out. Of course, the invention is not limited to the winding of a wire of rectangular or square cross section, rather the invention can be implemented whatever the cross section of the wire.

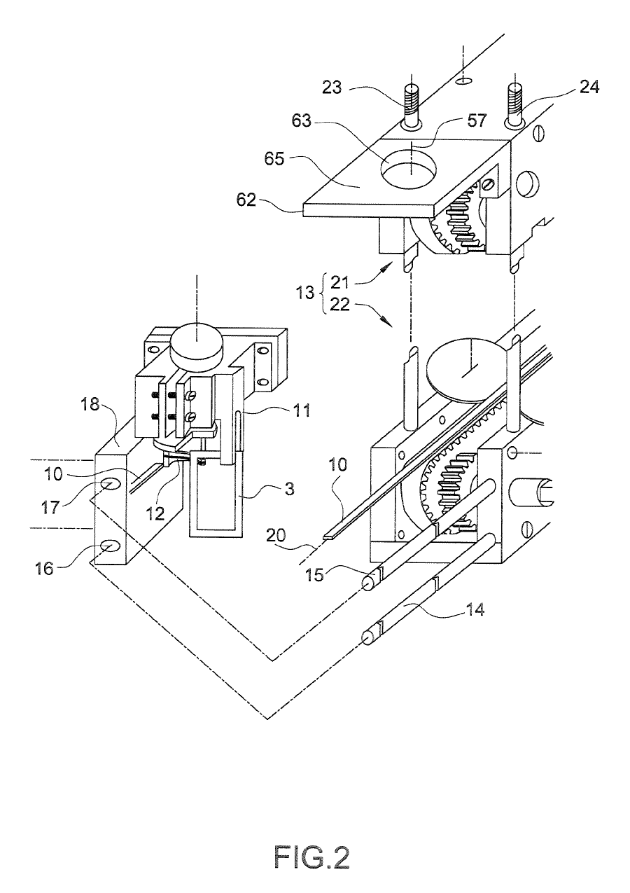

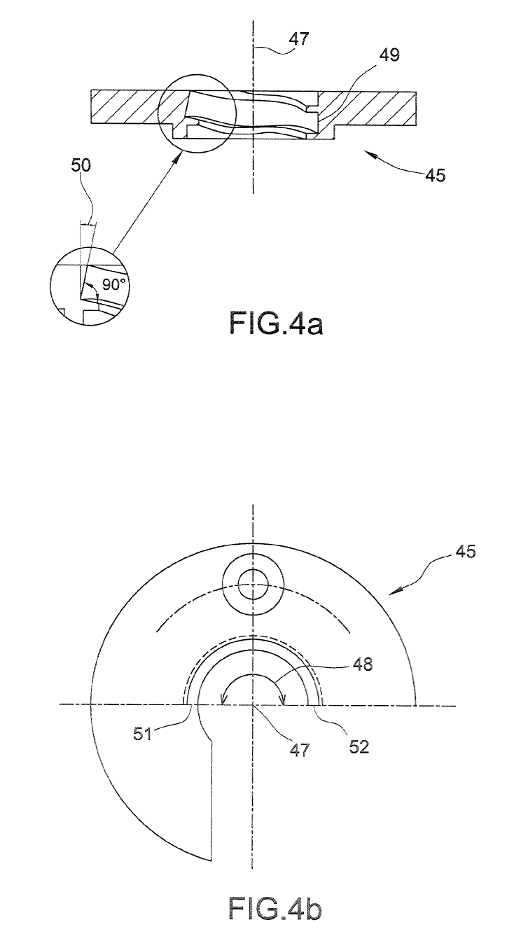

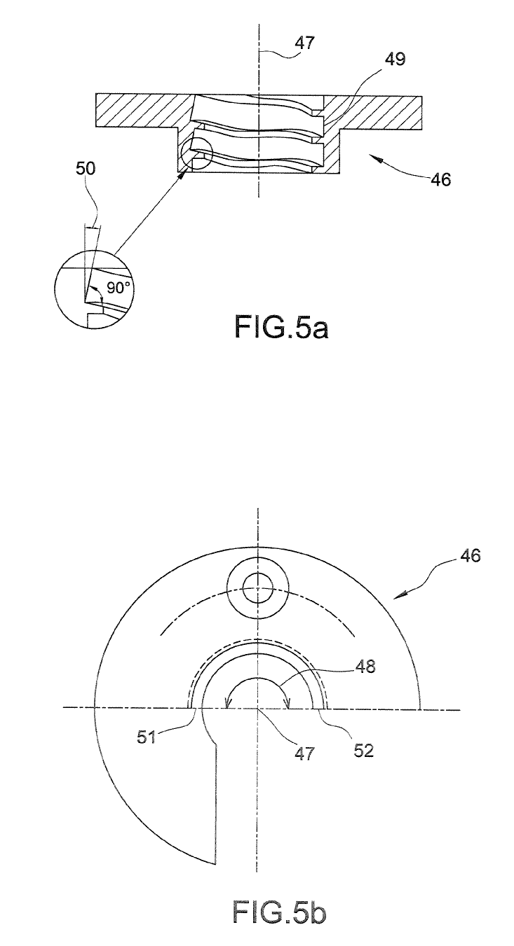

FIG. 2 shows a device for winding the coil of wire 10 according to the invention. The winding is performed for example around the magnetic circuit 3 already shown in FIG. 1. The device includes means 11 for holding the magnetic circuit 3 in a defined position. The holding means 11 comprise, for example, a clamp for temporarily fixing the position of the magnetic circuit 3 during the winding operation. The device includes a helicoidal channel 12 placed around the magnetic circuit 3. The shape of the helicoidal channel 12 will be described in greater detail using FIGS. 4 and 5. The device includes thrust means 13 for thrusting the wire 10 toward the helicoidal channel 12. To show the various elements of the device more clearly, the holding means 11 and the helicoidal channel 12 are shown away from the thrust means 13. To assemble them, the device includes, for example, two fingers 14 and 15 fastened to the thrust means 13 and intended to penetrate respective holes 16 and 17 made in a support 18 for the helicoidal channel 12.

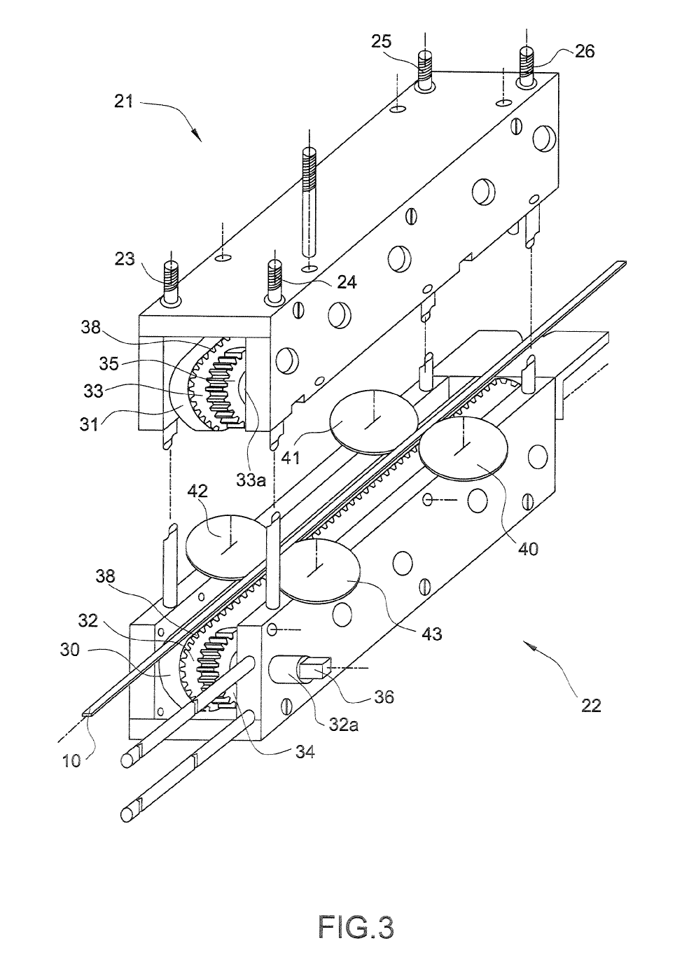

Before winding, the wire 10 is substantially straight. It extends along a direction 20, the direction along which the wire 10 is thrust. Advantageously, the thrust means 13 include means for applying pressure on the wire 10 approximately perpendicular to the direction 20 along which the wire 10 is thrust toward the helicoidal channel 12. More precisely, the thrust means 13 comprise an upper part 21 and a lower part 22, which are shown apart in FIGS. 2 and 3. The wire 10 is put under pressure between the upper part 21 and the lower part 22. Advantageously, the device includes means for adjusting the pressure exerted by the means for applying pressure on the wire. These adjustment means comprise, for example, four screws 23 to 26 for adjusting the clamping of the two parts 21 and 22.

Advantageously, the thrust means 13 comprise two belts 30 and 31 mounted back to back and driven at the same speed. The wire 10 is pinched between the two belts 30 and 31.

Advantageously, the belts 30 and 31 are each driven by a cogged pulley, 32 and 33 respectively. The two cogged pulleys 32 and 33 have the same number of teeth and are each fastened to a shaft, 32a and 33a respectively. The device includes two pinions 34 and 35 each fastened to one of the shafts, 32a and 33a respectively. One of the pinions, for example the pinion 34, drives the other one. The pinions 34 and 35 have the same number of teeth. Thus, the two belts 30 and 31 run against each other, without slippage, driving the wire 10. The shaft 32a is driven by motor means external to the device via a square operating rod forming part of the shaft 32a.

Advantageously, the belts 30 and 31 are cogged. The two cogged pulleys 32 and 33 cooperate with cogs 38 of the belts 30 and 31.

To improve the thrusting of the wire 10, the surface of the belts 30 and 31 which is in contact with the wire 10 comprises a material having a high coefficient of adhesion, such as for example rubber.

To avoid the risk of the wire 10 wavering as it progresses between the belts 30 and 31, the thrust means 13 may include means for guiding the wire 10. These guiding means comprise, for example, four wheels 40 to 43 that rotate freely with respect to the lower part 22 of the thrust means 13. These wheels pinch the wire 10 in pairs. The spacing of the wheels can be adjusted according to the cross section of the wire 10.

Two examples of helicoidal channels 12 are described with the aid of FIGS. 4a, 4b, 5a and 5b. FIGS. 4a and 4b show a helicoidal channel 45 that can be used to produce a coil comprising only a single wire. FIG. 4a shows this coil in a front view along the direction 20 and FIG. 4b shows it viewed from above.

FIGS. 5a and 5b show a helicoidal channel 46 that can be used to produce a coil comprising two wires wound simultaneously. FIG. 5a shows the helicoidal channel 46 in a side view along the direction 20 and FIG. 5b shows it viewed from above.

The helicoidal channels 45 and 46 wind around a helix axis 47 along an arc 48 around the helix angle 47, the arc 48 being open so as to allow the magnetic circuit 3 to be positioned along the helix axis 47. The extent of the arc 48 is for example at most 180°, thereby allowing the magnetic circuit 3 to be easily placed along the helix axis 47 and allowing the coil to be disengaged after winding.

Advantageously, the helicoidal channels 45 and 46 have a cross section complementary to the cross section of the wire 10. For example, the cross sections shown in FIGS. 4a and 5a are in the form of a U, an end wall 49 of which is suitable for receiving a wire 10 of rectangular cross section. The cross section is open toward the helix axis 47. The end wall 49 substantially faces the helix axis 47 and is advantageously inclined to the helix axis 47. The inclination 50 can be seen in greater detail in FIGS. 4a and 5a. The inclination 50 is that which the wire 10 forms after winding along the helicoidal channel 45 or 46.

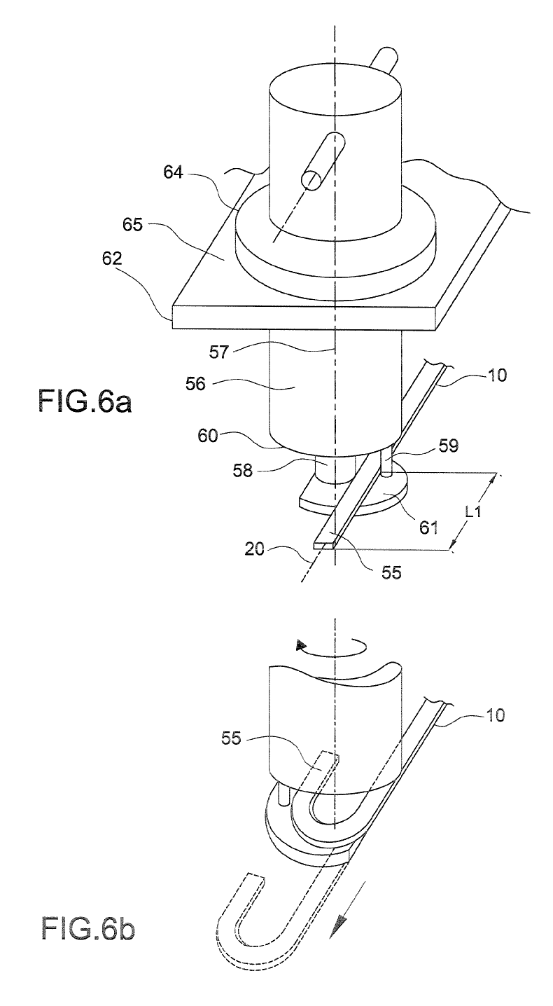

Advantageously, the device includes means for preforming a first half-turn of the coil, an exemplary embodiment of which is illustrated in FIGS. 6a and 6b. This allows a first end of the coil to retain a straight segment 55 of wire 10. The segment 55 facilitates electrical connection to the first end. This first half-turn also makes it easier for the wire to be inserted into the helicoidal channel 12.

The preforming means comprise a shaft 56 which can rotate about an axis 57 approximately perpendicular to the direction 20, and also two fingers 58 and 59 that are fastened to the shaft 56 and extend along the axis 57 in the case of the finger 58 and parallel to the axis 57 in the case of the finger 59. The direction 20 passes between the fingers 58 and 59. The fingers 58 and 59 extend from one end 60 of the shaft 56 as far as a flat plate 61, which is perpendicular to the axis 57. The direction 20 passes via the plane of the plate 61. The shaft 56 is rotated with respect to a nose 62 fastened to the upper part 21. The nose 62 can also be seen in FIG. 2. The nose 62 includes a cylindrical hole 63 of axis 57, the shaft 56 passing through the hole 63. The shaft 56 includes a flange 64 that bears on an upper face 65 of the nose 62.

To preform the first half-turn of the coil, the wire 10 is slid between the fingers 58 and 59, projecting from the fingers 58 and 59 by a length L1 of wire 10 that is sufficient to produce the segment 55. The dimension L1 is also indicated in FIG. 1. In the case of the coil 2, the dimension L1 may be at most equal to a dimension L2, mainly that of the space separating the coils 1 and 2 once they have been wound. This dimension L2 must be respected in the case of the second coil wound around the ring core 3. When the first coil is being wound round the ring core 3, the dimension L1 may be at most equal to a dimension L3 of the opening in the ring core 3.

Once the wire 10 has been slid between the fingers 58 and 59, the shaft 56 is rotated manually by means of an arm 66, fastened to the shaft 56, until the first-turn is produced as shown in FIG. 6b. The wire 10 is then advanced along the direction 20 so as to bring the half-turn into contact with the end wall 49 of the helicoidal channel 45 or 46. This forward position of the half-turn is shown by the dotted lines of FIG. 6b.

To use a device as described above, a method consists in:
engaging a first end of the wire 10 in the thrust means 13 for thrusting the wire 10 toward the helicoidal channel 12;
placing the ring core 3 in its defined position;
thrusting the wire 10 into the helicoidal channel 12 until the desired number of turns have been formed;
releasing the ring core 3 and disengaging the wire 10 from the thrust means 13; and
cutting a second end of the wire 10.

When the wire 10 is thrust into the helicoidal channel 12, the wire 10 penetrates the helicoidal channel 12 via an entry zone 51 and emerges from the helicoidal channel 12 via an exit zone 52.

Advantageously, the method consists in:
forming a first half-turn with the end of the wire 10; and
placing the half-turn in the helicoidal channel 12.

These two operations take place after the first end of the wire 10 has been engaged in the thrust means 13 and before the ring core 3 is placed in its defined position.

It will be readily seen by one of ordinary skill in the art that embodiments according to the present invention fulfill many of the advantages set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

1. A device for winding a coil of rigid wire around a ring comprising:
a helicoidal channel, means for holding the ring core Win a defined space within the helicoidal channel, and
thrust means for thrusting the wire toward the helicoidal channels, in that the helicoidal channel winds around a helix axis, in that the cross section of the helicoidal channel includes an end wall substantially facing the helix axis, in that the end wall is inclined to the helix axis and in that the inclination is that which the wire forms after winding along the helicoidal channel.

2. The device as claimed in claim 1, wherein the thrust means include means for applying pressure on the wire approximately perpendicular to a direction along which the wire is thrust toward the helicoidal channel.

3. The device as claimed in claim 2, including means for adjusting the pressure exerted by the means for applying pressure on the wires.

4. The device as claimed in claim 2, wherein the thrust means comprise two belts mounted back to back and driven at the same speed, and in that the wire is pinched between the two belts.

5. The device as claimed in claim 2, wherein are each driven by a cogged pulley, the cogged pulleys having the same number of teeth, in that each cogged pulley is fastened to a shaft, in that it includes two pinions each fastened to one of the shafts, in that one of the pinions drives the other one and in that the pinions have the same number of teeth.

6. The device as claimed in claim 5, wherein the belts are cogged and in that the shafts include cogs that cooperate with the cogs of the belts.

7. The device as claimed in claim 4, wherein the surface of the belts which is in contact with the wire comprises a material having a high coefficient of adhesion.

8. The device as claimed in claim 4, wherein the surface of the belts which is in contact with the wire comprises rubber.

9. The device as claimed in claim 1, wherein the thrust means include means for guiding the wire.

10. The device as claimed in claim 1, wherein including means for preforming a first half-turn of the coil.

11. The device as claimed in claim 1, wherein the helicoidal channel winds around a helix axis along an arc around the helix axis, the arc being open so as to allow the ring core to be positioned along the helix axis and to allow the coil to be disengaged after winding.

12. The device as claimed in claim 11, wherein the helicoidal channel has a cross section complementary to the cross section of the wire, and in that the cross section is open toward the helix axis.

13. The device as claimed in one of the preceding claims, wherein the extent of the arc is at most 180°.

14. A method of winding a coil of rigid wire around a ring core, the method employing a device as claimed in claim 1, comprising the steps of:
engaging a first end of the wire in the thrust means for thrusting the wire toward the helicoidal channels;
placing the ring core in its defined position;
thrusting the wire into the helicoidal channel until the desired number of turns have been formed;
releasing the ring core and disengaging the wire from the thrust means; and
cutting a second end of the wire.

15. The method as claimed in claim 14, comprising:
forming a first half-turn with the end of the wire; and
placing the half-turn in the helicoidal channel,
these two operations taking place after the first end of the wire has been engaged in the thrust means and before the ring core is placed in its defined position.

16. The device as claimed in claim 3, wherein the thrust means comprise two belts mounted back to back and driven at the same speed, and in that the wire is pinched between the two belts.

17. The device as claimed in claim 5, wherein the surface of the belts which is in contact with the wire comprises a material having a high coefficient of adhesion.

18. The device as claimed in claim 5, wherein the surface of the belts which is in contact with the wire comprises rubber.

19. The device as claimed in claim 2, wherein including means for preforming a first half-turn of the coil.

20. The device as claimed claim 2, wherein the helicoidal channel winds around a helix axis-along an arc around the helix axis, the arc being open so as to allow the ring core to be positioned along the helix axis and to allow the coil to be disengaged after winding.
